(19) United States
(12) Patent Application Publication
(10) Pub. No.: US 2009/0301649 A1
(43) Pub. Date: Dec. 10, 2009

(54) Manufacturing method for packaging and advertising means

(75) Inventors: Gerhard Augsberg, Seligenstadt (DE); Jens Kaiser, Offenbach/Main (DE); Dirk Meinhardt, Seligenstadt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach (DE)

(21) Appl. No.: 12/090,443

(22) PCT Filed: Oct. 17, 2006
(86) PCT No.: PCT/EP06/09990

§ 371 Date: Jul. 25, 2008

(30) Foreign Application Priority Data
Oct. 20, 2005 (DE) 10 2005 050 656.9

(51) Int. Cl. B41F 5/04; B44C 1/175

(52) U.S. Cl. 156/237; 101/217

(57) ABSTRACT

The purpose is to improve the usability of the film coating in a coating module for the transfer of image-forming layers from a transfer film to a printing material. A film transfer module is, for that purpose, arranged in a printing machine for the single-color or multicolor printing of printed sheets. Moreover, one or more coating installations, in the form of varnishing modules, are arranged before and/or after the printing machine. By the application of layers, a subject consisting of a film image and a printed image is coated over part of the surface or over the entire surface. The additional coats serve the function of providing protection, drying, or generating optical effects.

### FIELD OF THE INVENTION

The present invention relates generally to a method and apparatus for the manufacture of coated packaging and advertising means under enclosure of transfer-image-providing layers of a carrier film on printed sheets.

### BACKGROUND OF THE INVENTION

The manufacture of metallic layers on printed sheets by means of a film transfer method is known. EP 0 569 520 B1, for example, discloses a printing material and a printing device which uses this material. Here, a sheet processing machine is shown, which includes a feeder and a deliverer, with printing devices and a coating module arranged between the two units. In at least one of the printing devices, an adhesive pattern is applied by means of a flat printing method. This adhesive pattern is applied in a cold printing method, and it presents a certain image-forming subject. In a coating module that follows the printing device and that includes an impression cylinder and a printing roller, a film guide is provided. This guide is designed in such a way that a film strip or transfer film is guided from a film reserve spool through the transfer slit of the coating module between the impression cylinder and the press roll. The film strip is again wound on the outlet side after it leaves the coating module. The transfer film presents a carrier layer on which image-forming layers, such as metallic layers, for example made of aluminum, can be applied. Between the metallic layer and the carrier film, a separation layer is provided, which ensures that the metallic layer can be pulled off the carrier layer.

During the transport of the printed sheet through the printing device, each printed sheet is provided with an adhesive pattern. Then, the printed sheet is guided through the coating module, where, by means of a press roll, the printed sheet that lies on the impression cylinder is brought in contact with the film material. In the process, the metallic layer that lies downward comes in close contact with the areas of the printed sheet that are provided with adhesive. After the printed sheet is transported further, the metallic layer adheres only in the area of the pattern that is provided with adhesive. The metallic layer is thus removed from the carrier film in the area of the adhesive pattern. The transfer film that is consumed in this way is again wound. The printed sheet is delivered in the coated state.

It is known to use such coating modules, for example, in printing devices of printing machines. The drawback in the known devices is that they cannot be used flexibly. Furthermore, the surface shaping is frequently not uniform as a result of the differently shaped surface properties of the different layers.

### OBJECTS AND SUMMARY OF THE INVENTION

It is an object of the invention to provide a method and a device for transferring an image-forming layer, for example, a metallization layer, onto a printed sheet, reliably, economically, and precisely.

Another object is to provide such a device that can be readily used in a broader range of applications for the production of variable surface properties.

In carrying out the invention, an integrated printed image design of film image parts and printed image parts is combined. To support the effect, a varnish layer made of clear or transparent or color glazing varnish is applied on the printed sheet. As a result, the printed image is protected and its shine effect is particularly enhanced. The drying advantageously occurs very rapidly so that further processing is not delayed.

In keeping with the invention, a printing machine is provided that is more flexible in its operation by the integration of a film transfer module. The film transfer module can be designed as a part of a printing device, as a separate work station, as an integrated work station, or as a convertible work station.

Advantageously, the film transfer module can be arranged at different places within a printing machine, depending on the application purpose. Therefore, it is also advantageously possible to provide several coating modules one after the other within a machine that processes a sheet. In this way, the application of different image-forming coatings or metallization coatings can occur sequentially within one subject. Here, it is possible to transfer the image-forming layers next to each other with all the image pattern elements over a single adhesive pattern.

It is also possible to provide a first adhesive pattern in a first coating module with a first image-forming coating or a metallization layer, and, by superposition, to then apply an additional adhesive pattern that encloses the first one, and provide it with another image-forming coating or metallization layer.

Furthermore, the film transfer module in a sheet printing machine can also be arranged after an installation for reversing a sheet so that an image-like coating from the film transfer occurs on the back side of a sheet after a previous printing on the front side.

To improve the coating properties, the image-forming layer can be applied by means of so-called UV low-pressure ink, by means of a printing device for the adhesive, in, for example over, an offset printing plate.

Other objects and advantages of the invention will become apparent upon reading the following detailed description and upon reference to the drawings, in which:

### BRIEF DESCRIPTION OF THE DRAWINGS

FIG. 1 is a partially diagrammatic elevational view of a printing machine having a film transfer system in accordance with the invention; and

FIGS. 2-5 depict alternative configurations with film transfer modules integrated into a printing machine according to the invention.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DESCRIPTION OF THE PREFERRED EMBODIMENTS

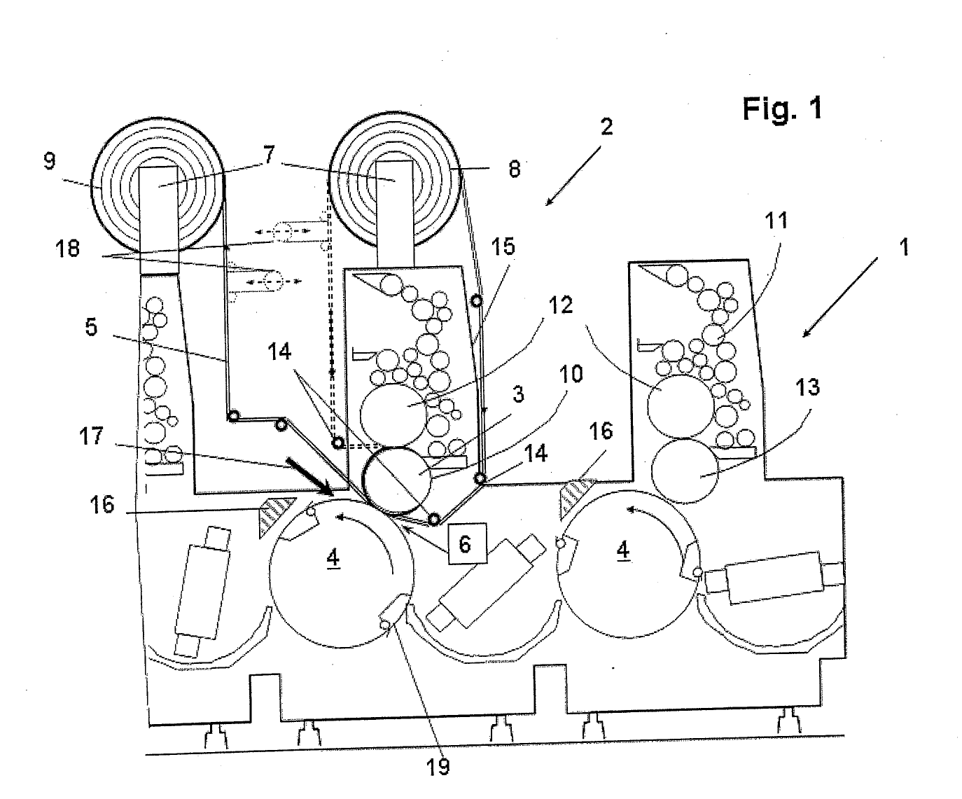

Referring now more particularly to FIG. 1 of the drawings, there is shown an illustrative sheet processing machine, in this case a printing machine, which consists of one or more printing devices that are used for various purposes, as set forth below, consistent with the invention.

A printed sheet to be coated is provided in a first work step in an application device 1 (i.e., printing device, varnishing module, or similar device) with an image-forming adhesive pattern. For example, in a printing device of an offset printing machine, by means of inking/damping devices 11, a printing plate on a plate cylinder 12, a printing blanket cylinder or rubber cylinder 13, a printed sheet is printed on at an impression cylinder 4.

Application devices can also be used in configurations as a flexoprinting unit or lacquering device (see the embodiment in FIG. 4). The adhesive can be transferred by means of a dosing system via an anilox roll and a transfer roller on a forming cylinder, which, for this purpose, carries a high-pressure printing plate for the generation of the image-forming adhesive application.

In a second step, in a coating module 2, together with the printed sheet, a transfer film 5 is guided through a transfer slit 6, where the transfer film 5 is pressed in the transfer slit 6 against the printed sheet. The coating module 2 can correspond to a printing device, a varnishing module, a base unit, or other type of processing station of a sheet offset printing machine, or integrated in them. The transfer slit 6 in the coating module 2 in this case is formed by a press roll 3 and an impression cylinder 4.

The press roll 3 can be the printing blanket cylinder 13 of an offset printing device or the forming cylinder of a varnishing module of a sheet printing machine. In each case, the impression cylinder 4 is provided in the corresponding processing station.

The press roll 3 is provided with a press covering 10 or a corresponding coating. The press covering 10 or press coating can be designed, for example, as a plastic coating, similar to a rubber blanket or printing blanket. The surface of the press covering 10 or press coating is preferably very smooth. It can also be formed from anti-adhesive substances or structures.

Furthermore, a delimited press surface can be provided on the press roll 3 or on the press covering 10. The press surface can be provided in the surface of the press covering 10, or it can be attached additionally on the press roll 3 as a partial surface made of the material of the press covering 10.

Furthermore, a calendering device can be provided after the coating module 2 to increase the adhesion of the coating or to increase the smoothness and the shine of the printed sheet when the coated printed sheet is to be rolled over under increased pressure.

Moreover, additional printing devices of a sheet offset printing machine can be provided and connected after the coating module 2 if the coated printed sheet is to be processed further in-line printing on with a single-color or multicolor image.

Moreover, a varnishing module can be provided and connected after the coating module 2 if the coated printed sheet is to be provided with a corresponding covering to improve the adhesion of the coating, to protect the coating from accelerated drying and/or to increase the smoothness and shine of the printed sheet.

Within the coating module 2, which is used for a film transfer, a web guide for transfer films 5 is provided.

Transfer films 5 that can be considered for processing are designed in multiple layers. They present a carrier layer on which an image-forming layer is applied by means of a separation layer. The separation layer serves to facilitate the lifting or separation of the image-forming layer from the carrier layer. The image-forming layer can be, for example, a metallized layer or a shiny layer or a texture layer, or a dyed layer, or a layer containing one or more image patterns.

The transfer film 5 can be drawn from a film reserve spool 8 of the coating module 2 on a side of the sheet feed. The film reserve spool 8 includes a turning drive 7 for the continuously regulated feeding of the transfer film 5 toward the coating module 2.

Furthermore, in the area of the film feed and removal guide devices 14 are provided, such as deflection or tension rollers, pneumatic pressure regulated guide means, metal guide plates or similar parts. In this way, the web of the transfer film 5 can always be held evenly without deformation and with the uniform tension about the press roll 3.

The transfer film 5 is thereby guided around the press roll 3 (see the broken-line representation). The film web can here be guided in close parallelism as a function of the available space conditions on one side of the coating module 2 in the feeding and the removal strand. The transfer film 5 can be guided essentially tangentially past the press roll 3, or it can be guided so it loops around the latter over only a small peripheral angle through the press slit 6, while it is fed from one side of the coating module 2 and removed from the opposite side.

On the outlet-side side of the printing device, a film collection spool 9 is provided, on which the used film material is wound. Here too, a controllable rotating drive 7 is provided.

To improve the cost effectiveness of the coating method, the advance of the transfer film 5 from the film reserve spool 8 to the transfer slit 6 and to the film collection spool 9 is controllable so that the transfer film 5 is held still, to the extent possible, when no transfer of the image-forming layer should occur.

In rapid-reacting cycling systems over so-called dancer rollers 18, as depicted in the drawing of FIG. 1, control of the rotating drive 7 of the film reserve spool 8 or the film collection spool 9 may not be required. The required film tension in that case may be maintained by means of the dancer rollers 18.

An additional improvement of film utilization can be achieved if the transfer film 5 is divided into one or more partial film webs of small width. Here, under appropriate control, and with the help of an installation or installations for cycling the film advance of each one of the partial film webs, the utilization of the transfer film 5 also can be improved by using coating areas with areas of different length within a sheet.

Moreover, to improve the coating method, a dryer 16 is provided in the area of the adhesive application and in the area of the film application. Thus, particularly by UV drying, the image-like applied adhesive layer can be predried by means of a first dryer 16 (intermediate dryer I), so that the useful layer of the transfer film 5 adheres better. Moreover, the adhesive effect of the impressed useful layer on the printing web can be improved by the action of a second dryer 16 (intermediate dryer II) by additionally accelerating the drying of the adhesive.

According to the invention, different possibilities exist for carrying out the image-like coatings by means of an image-forming or metallization layer within a work unit or printing devices at different positions in a printing machine.

Moreover, an embodiment of an integrated film transfer module can be used in a sheet-processing machine. In that case, the coating module 2 can be designed to be integrated into the construction of the application device 1.

A sheet-guiding impression cylinder 4 for the transport of the printed sheets includes one or more gripper sections with one or more associated pressure surfaces about the periphery. Moreover, a coating module 2 is associated with the impression cylinder 4, and includes a press roll 3, which forms a transfer slit 6 with the impression cylinder 4. The transfer slit 6 is arranged after the coating slit of the application device 1 at the impression cylinder 4 in the direction of movement of the sheet.

In this way, an integrated film transfer module is formed, which presents two work stations that are used for the following work steps. The print substrate is, in such a film transfer module, guided very advantageously through all the necessary slit locations in a single gripper closure, while it lies on a single impression cylinder 4.

The coating module 2 or the integrated film transfer module is effective appropriate for providing a printed sheet with an image-forming layer, for example, a metallization layer before it is printed. Within the sheet-processing machine that includes the coating module 2 or the integrated film transfer module, for example, can be placed a sheet offset printing machine, and a coating module, and they can also be placed at any other place within the machine. This allows for the desired image-forming layers, such as, for example, metallization layers, to be applied both before, and also after or between, the application of printing ink layers.

With means of the described device, a high-value packaging or advertising means can be finished in an effective way.

In principle, the arrangement of the coating module 2 or of the integrated film transfer module allows the application of a film pattern made of a metal film or other effective film on a printed sheet.

Depending on the quality of the print substrate, it may be advantageous or necessary for the print substrate to be precoated in order to adapt its surface to the quality requirements of the finishing. For this purpose, in an appropriate printing machine, one or more varnishing modules L can be connected before the first printing device or before the application device 1 and the coating module 2 or the integrated film transfer module, with the varnishing modules enabling the application of a primer layer on the printed sheet.

During the application of the film pattern, a conventional adhesive similar to an offset printing ink can be used. A UV adhesive can also be used. In both cases, predrying of the adhesive layer can occur.

During the application of the film pattern on the transfer film 5, the latter can be preheated by means of appropriate devices in order to facilitate the detachment of the image-forming layer or metallization layer from the film carrier and thus improve the transfer of the film pattern.

After the application of the film pattern, a color image can be printed on the film image. For this purpose, conventional offset printing inks or film inks or UV printing inks can be used in the appropriate printing devices. The drying effect and the adhesion of the conventional printing inks on the film image because they dry to a large extent as a result of absorption. Film inks are generally oxidatively hardening printing inks, which adhere better, but also require a relatively long drying time. UV printing inks are used to achieve a rapid drying using a UV dryer.

Depending on the type of printing ink used for the formation of the color image on the film image, it may be necessary to add a drying process for further treatment of the printed sheet. Here it is important that the printed sheet possess a certain lack of homogeneity due to the nearly glued-on film image. Therefore, a good dosing of drying energy is necessary.

A not-yet dried printed sheet, which carries a film image and a color image, can be protected in an effective way against damage or soiling by applying a varnish layer. Here, it is possible to use dispersion varnishes, so-called primers in combination with dispersion varnishes or UV varnishes. By means of such rapidly drying varnish layers, it is possible, on the one hand, to provide good protection for a printed sheet that is provided with a coating comprised of a film image and a printed image, where the adhesive and printing ink layers can finish hardening under the varnish layer. On the other hand, the surface of such a printed sheet additionally receives a finishing by this process. In addition to receiving a more even appearance, the surface also receives a very desirable shine effect. Here, the surface of the film image is additionally protected against oxidative influences.

The varnishes used may be transparent or translucent, or they may be clear or colored. By means of appropriate color ink-varnish combinations, for example, combinations of conventional printing ink or the use of a so-called primer and a UV varnish, the surface of the printed sheet can also be provided with areas having different degrees of shine.

For the above mentioned process steps, the following production sequences can be used:

a. Precoating (with compensation or protective medium, optionally in adaptation to the adhesive properties)

b. Adhesive application (with conventional or UV adhesive)

c. Optional predrying of the adhesive

d. Film application (optionally under slight heating of the transfer film)

e. Optional post-drying of the adhesive

f. Single- or multicolor printing of a color image with enclosure of the areas of the film application (with conventional offset printing ink or film color ink or UV printing ink)

g. Optional intermediate drying of the printed color image

h. Application of a shiny or protective layer made of transparent varnish (with a dispersion varnish or a primer in combination with a dispersion varnish or a UV varnish)

i. Optional final drying of the finished coated printed sheet.

As possible product variants of the mentioned production steps, several variants are represented in more detail below.

I. On a simple, nonsmooth print substrate, in a varnishing module, a compensation composition is applied that makes the surface smooth and resistant. In combination with the later applied adhesive for the film image, particularly strongly adhesive areas for the metallization layer are achieved. The printed sheet is printed on after the application of the film image with a multicolored printed image made of film color ink. This applies particularly to printed sheets with a high surface proportion of the film image. The color image dries oxidatively and is not protected. It presents a good shine, but it is relatively rough to the touch.

II. On a smooth print substrate, a printing subject of a UV adhesive for the film image is applied, which can be subjected to intermediate drying. On the adhesive subject, a film or metallization layer is transferred and optionally again subjected to intermediate drying. The printed sheet is printed on after the application of the film image with a single- or multicolored printed image made of UV printing ink. This applies to printed sheets with a low to high surface proportion of the film image. Drying of the color image is finished by means of a UV dryer, but it is not protected in the surface. The printed sheet presents a good shine, and very good smoothness to the touch.

III. On a smooth print substrate, a printing subject of a conventional adhesive for the film image is applied, on which a film or metallization layer is transferred. The printed sheet is then printed on with a single- or multicolor printed image made of conventional offset printing ink (printed sheet with low to high film proportion). The color image is optionally dried by means of a dryer. On the printed sheet, an invisible primer for conferring adhesiveness is applied and then protected by means of a layer made of UV varnish. Then, a final drying can occur. The printed sheet presents a very good shine, and it is very smooth to the touch. The shiny effects of the film areas are easily attenuated and thus subjected to an optically more pleasing compensation effect. The printed sheet is immediately dry and can be processed further.

IV. On a smooth print substrate, a printing subject of a UV adhesive is applied for the film image, on which a film or metallization layer is transferred. The printed sheet is then printed on with a single- or multicolor printed image made of UV printing ink (pressure sheet with low to high film proportion). The color image is optionally dried by means of a UV dryer and protected by means of a layer made of UV varnish. Then, final drying can occur. The printed sheet presents a very good shine and it is very smooth to the touch. The shiny effect of the film area, particularly films with iridescent or diffracting effects, is supported, and its effect clearly enhanced. The printed sheet dries immediately and can be processed further.

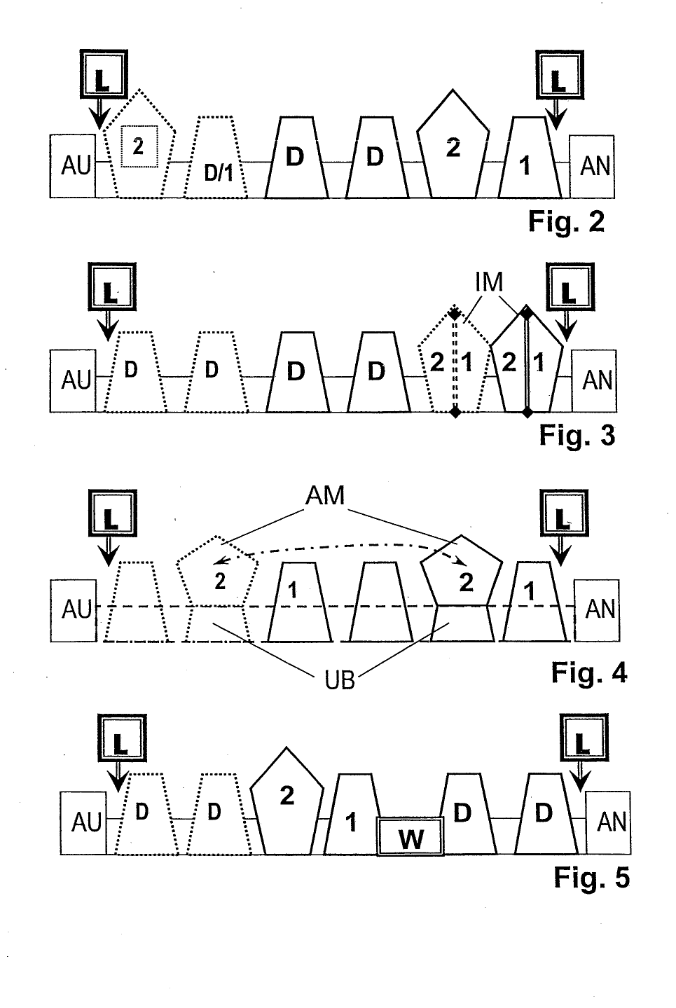

FIGS. 2-5 schematically depict different combinations of possibilities for the inclusion of coating modules 2 and application devices 1 in a printing machine for carrying out the described production methods for packaging means or advertising means.

In all the configurations shown, one or more varnishing modules L can be connected before the printing machines and after a film transfer module or printing device D that is provided with a feeder AN, to enable the application of a compensation layer, a primer layer, or a precoating of different types on the printed sheets.

In all the configurations shown, one or more varnishing modules L can be connected after the printing devices D before a deliverer AU. In this way, a single- or multilayer transparent and clear, shiny or colored cover layer can be applied. An intermediate dryer can be arranged between such varnishing modules L.

In the configuration shown in FIG. 2, after sheet feeder AN, an application device 1 is connected first, and then a coating module. Again, printing devices D of the sheet printing machine follow the coating module 2. A sheet deliverer AU terminates the configuration.

By means of this configuration, an image-like coating can occur with a metallized film on the empty printed sheet. Then, a multicolored printed image can be applied on this coating. By means of the coating module 2, a full-surface coating with metallized film can also be prepared, which can be overprinted subsequently in the printing devices D. A coating module 2 can also be connected after the printing devices D before the sheet deliverer AU, where the printing device D, which is arranged before the coating module 2, can function as application device 1. By means of this arrangement, a subsequent lamination or the application of a metallized image-like coating without over printing is possible. For this purpose, the color print should be dried beforehand.

FIG. 3 shows a configuration similar to that of FIG. 2. In this case, two film transfer modules are arranged as integrated coating modules IM after the sheet feeder AN. Here, within a work unit, both a coating module 2 and also an associated application device 1 are arranged (see also FIG. 2). In this way, according to an above indicated process example, the image-like application of two different, juxtaposed, but mutually overlapping coatings can be carried out. The arrangement of an integrated coating module IM is advantageous, particularly if at least two film transfer modules are to be arranged directly one after the other.

In FIG. 4, a flexible variant is shown for a printing machine with further improved properties of the further processing of printed sheets. The film transfer module is designed here as an attachment module AM. Such an attachment module AM is designed preferably as a transportable unit, and it can be placed on a standardized substructure UB of a printing device D of the printing machine. For this purpose, appropriate coupling mechanisms are required, which can be constructed in various ways. The substructure UB normally includes a frame in which a sheet transport drum and an impression cylinder 4 are attached in a mutual arrangement. Optionally, on the substructure, a printing blanket cylinder 13 of an offset printing device or a forming cylinder 20 of a varnishing module can be associated in each case with an impression cylinder 4. The printing blanket cylinder 13 or forming cylinder 20 can be used in connection with the coating module 2 as press roll 3, where an appropriate covering 10 must be applied. Corresponding tensioning devices are present on both cylinder construction forms.

In FIG. 5, a further variant is shown. In this instance, the printing machine includes a reversing device W after after two printing devices D that follow the sheet applier AN. Reversing devices W are used to reverse a printed sheet that has been printed on or coated on one side during the sheet run of a sheet printing machine so that the side that was the under side becomes the upper side, which can then be printed on or coated. In the configuration shown, the reversing device W is followed by an application device 1 and a coating module 2. Then, several optional additional printing devices D are provided up to the sheet deliverer AU.

With such a printing machine, any printed sheet can thus be printed on, first on its back side with one or two colors, then it can be reversed, then it can receive an image-forming coating with a metallized layer, and then it can be printed on again with several colors. Greeting cards with decorative inserts made of metal film on the image side are an application example of this.

The configurations shown are indicated as examples. In the context of the modularization of the film transfer module, as presented above in detail, the person skilled in the art will appreciate additional application possibilities without difficulty.

### List Of Reference Numerals

1 Application device

2 Coating module

3 Press roll

4 Impression cylinder

5 Transfer film/film web

6 Transfer slit

7 Roller drive

8 Film reserve spool

9 Film collection spool

10 Press covering

11 Inking/damping device

12 Plate cylinder

13 Printing blanket/rubber cylinder

14 Film guide installation

15 Printing device protection

16 Dryer

17 Inspection installation/monitoring system

18 Dancer roller

19 Cylinder duct

D Printing device

W Reversing installation

AN Sheet feeder

AU Sheet deliverer

UB Substructure

IM Integrated film transfer module

AM Application module

L Varnishing module

1-14. (canceled)

15. A method of producing image forming layers on a sheet in a printing machine having an application device (1) and a coating module (2) comprising the steps of:
applying an image-forming adhesive coating on the sheet by means of the application device,
subsequently applying a film image on the sheet by said coating module (2) by the transfer of at least parts of an image forming layer of a transfer film onto the sheet,
after application over printing of the film image, over printing the printing sheet with a single color or multi-color printed image using printing inks, and
after application of the printed image applying a single-layer or multi-layer transparent or translucent coating over the combined film and printed images.

16. The method of claim 15 including applying a single layer or multiple layer preliminary coating on the sheet by one or more varnishing modules before application of the film image by the coating module.

17. The method of claim 16 in which said preliminary coating is a medium that adhesively couples to the image forming adhesive coating.

18 The method of claim 15 in which said single color or multi-colored printed image is formed by conventional offset printing ink, an oxidatively drying film ink, or a UV printing ink.

19. The method of claim 15 in which said transparent or translucent coating is formed by applying to the sheet a dispersion of varnish, a UV varnish, or a combination of adhesive producing primer and a UV varnish.

20. The method of claim 15 including over printing said single color or multi-color printed image by means of conventional offset printing ink or film printing ink, and then coating the sheet with a dispersion of varnish applied over a part of or the entire surface of the sheet.

21. The method of claim 15 including forming said single color or multi-color printed image by over printing a conventional offset printing ink or a film printing ink, and then coating the printed sheet with a single layer or multi-layer coating of an adhesive-enhancing primer over the entire surface or part of the surface of the sheet, and then applying a UV varnish over a part of or the entire surface.

22. The method of claim 15 including over printing the sheet with a single color or multi-color UV printing ink, and then coating the printed sheet with a single layer or multi-layer coating of UV varnish over part of or the entire surface of the sheet.

23. The method of claim 15 in including applying said image forming adhesive coating with a UV adhesive.

24. The method of claim 15 including drying the sheet after applying the image forming adhesive coating and/or after over printing with said printing inks and/or after applying said transparent and/or translucent coating.

25. A printing machine for producing image forming layers on a sheet comprising:
an application device (1) for applying an image forming adhesive coating on the sheet,
an impression cylinder (4) and press roll (3) which define a transverse slit (6),
a coating module (2) downstream of said application device (1) for applying a film image on the sheet by the transfer of at least parts of an image forming layer of a transfer film onto the sheet as it passes through said transverse slit (6),
said coating module including a feeding device for directing said transfer film from a supply to said slit and for removing consumed film from said transverse slit,
guides for directing the film to and from said transverse slit,
a printing device after said coating module for applying a printed ink image to said sheet,
and at least one varnishing module after the printing device for applying a transparent or translucent coating to the sheet.

26. The printing machine of claim 25 including a plurality of printing devices (D) for generating a color overprint on said film image, and said coating module being disposed between the printing devices.

27. The printing machine of claim 25 in which said coating module (2) is a film transfer module integrated in the printing machine adjacent the application device.

28. The printing machine of claim 25 including a dryer for drying the sheet before or after the coating module, and/or after the printing device and/or after the varnishing module.
